(19) United States
(12) Patent Application Publication
(10) Pub. No.: US 2002/0003877 A1
(43) Pub. Date: Jan. 10, 2002

(54) Encryption method, decryption method, cryptographic communication method, cryptographic communication system, memory product and data signal embodied in carrier wave

(75) Inventors: Kiyoko Katayanagi, Otsu-shi (JP); Yasuyuki Murakami, Kyoto-shi (JP); Masao Kasahara, Mino-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 09/862,888

(22) Filed: May 21, 2001

(30) Foreign Application Priority Data
May 24, 2000 (JP) 2000-153358
Oct. 6, 2000 (JP) 2000-307822
Mar. 29, 2001 (JP) 2001-97701

(51) Int. Cl. H04L 9/30

(52) U.S. Cl. 380/30; 380/277

(57) ABSTRACT

Providing an encryption scheme which is invulnerable to the low-density attack based on the LLL algorithm and capable of improving the security. Ciphertext is obtained by a product-sum operation of the components of a composite vector, which is obtained by adding a random number vector whose components are arbitrarily selected random numbers to a plaintext vector obtained by dividing plaintext to be encrypted, and the components of a public-key vector modulo-transformed based on one or a plurality of base vectors which, are set such that Vᵢ=(d/dᵢ)·vᵢ (where d=d₁d₂ . . . d_{K}) by using one or a plurality of sets of integers dᵢ(1≦i≦K). The positions of the components of the plaintext vector or random number vector in the composite vector are arbitrarily set by an entity as the sender or an entity as the receiver.

### BACKGROUND OF THE INVENTION

The present invention relates to public-key cryptosystems for transforming plaintext into ciphertext by using a public key, and more particularly relates to product-sum type cryptosystems.

In the present society called highly information-oriented society, on the basis of computer networks, important business documents and image information are transmitted/communicated in the form of electronic information and processed. Such electronic information has characteristics that it can be easily copied and it is hard to distinguish between the copies and the original, and thus the problem of information security is regarded as an important issue. In particular, the realization of computer networks satisfying the elements “sharing computer resources”, “multi-access”, and “wide area network” is indispensable for establishment of the highly information-oriented society, and this includes elements that contradict the maintenance of information security between the concerned parties. As the effective means for solving such controversy, cryptographic techniques which have been used mainly in the military and diplomatic fields in the past human history are attracting attentions.

Cryptography is to transform information so that the meaning of the information is not understandable by parties who are not concerned. In cryptography, a process of transforming the original text (plaintext) which is understandable by everyone into a text (ciphertext) whose meaning is not understandable by the third party is encryption, a process of returning the ciphertext into the plaintext is decryption, and the entire processes of encryption and decryption are called a cryptosystem. Secret information called an encryption key and a decryption key is respectively used in the encryption process and the decryption process. Since the secret decryption key is necessary for decryption, only the party who knows this decryption key can decrypt the ciphertext, and thus the secrecy of the information is maintained by encryption.

The encryption schemes are mainly classified into two types: common-key cryptosystems; and public-key cryptosystems. In the common-key cryptosystems, the encryption key and the decryption key are identical, and the sender and the receiver perform cryptographic communication by possessing the same common key. The sender encrypts the plaintext based on a secret common key and transmits the ciphertext to the receiver, while the receiver decrypts the ciphertext into the plaintext by using this common key.

By contrast, in the public-key cryptosystems, the encryption key and the decryption key differ from each other, and the sender encrypts the plaintext with the receiver's publicized public key and the receiver decrypts the ciphertext by its own secret key to perform cryptographic communication. The public key is a key for encryption and the secret key is a key for decrypting ciphertext which was transformed by the public key, and the ciphertext transformed by the public key can be decrypted only by the secret key.

As one scheme of public-key cryptosystem, a product-sum type cryptosystem has been known. This is an encryption scheme in which one entity as the sender creates ciphertext C−m₁c₁+m₂c₂+ . . . + mₖcₖ by using a plaintext vector m=(m₁, m₂, . . . , mₖ) obtained by dividing the plaintext into K parts and a base vector c=(c₁, c₂, . . . , cₖ) as the public key, while the other entity as the receiver decrypts the ciphertext C into the plaintext vector m by using the secret key to obtain the original plaintext.

Regarding such product-sum type cryptosystems using an operation over an integer ring, while novel schemes and attacking methods have been proposed one after another, there is a demand for particularly encryption/decryption techniques that enable high-speed decryption so as to process a large volume of information in a short time. Accordingly, the present inventor et al. propose an encryption method and decryption method according to a product-sum type cryptosystem, which enable high-speed parallel decryption processing by using the Chinese Remainder Theorem (Japanese Patent Application Laid-Open No. 2000-89669). This encryption method is characterized by modulo-transforming the components cᵢ(i=1, 2, . . . , K) of the base vector c based on bases Dᵢ which are set such that Dᵢ=d/dᵢ (where d=d₁d₂ . . . dₖ) by using mutually prime K integers dᵢ, or based on bases Vᵢ which are set such that Vᵢ=(d/dᵢ)vᵢ by using mutually prime K integers dᵢ and random numbers vᵢ(gcd(dᵢ, vᵢ)=1). Thus, since the ciphertext is decrypted in parallel ways using the Chinese Remainder Theorem, it is possible to perform high-speed decryption.

In this scheme, however, since the density is low unless the number of public keys is made extremely large, there is a problem that this scheme is sometimes weak against the low-density attack which directly finds the plaintext from the public keys and the ciphertext by using the LLL (Lenstra-Lenstra-Lovasz) algorithm, and thus there is a demand for a further improvement in its security aspect.

### BRIEF SUMMARY OF THE INVENTION

An object of the present invention is to provide an encryption method and decryption method, which are invulnerable to the low-density attack and capable of improving the security, by improving the above-mentioned conventional examples, and also to provide a cryptographic communication method and cryptographic communication system using this encryption method, and a memory product/data signal embodied in carrier wave for recording/transmitting an operation program of this encryption method.

In the present invention, ciphertext is created by giving redundancy to plaintext, i.e., reducing the plaintext. In other words, a composite vector is created by adding a random number vector consisting of random number components, which have no need of transmission of information particularly, to a plaintext vector obtained by dividing the plaintext to be encrypted, and the ciphertext is created using this composite vector and a publicized public-key vector. More specifically, the product-sum operation result of the components of the composite vector and the components of the public vector, or a remainder obtained by dividing the product-sum operation result by a modulus, is made the ciphertext.

In the present invention, since a redundant portion (reduced portion) which needs not be encrypted is added, the density of the ciphertext becomes higher. Moreover, since a very large number of composite vectors, i.e., a very large number of ciphertext, exist for a single plaintext vector, it is extremely difficult to make the low-density attack based on the LLL algorithm. As a result, the security is improved.

For example, ciphertext is created using a third vector (extended plaintext vector) formed by combining a first vector (plaintext vector) obtained by dividing plaintext to be encrypted and a second vector (pseudo plaintext vector) consisting of random number components which have no need of transmission of information particularly, and one or a plurality of fourth vector (base vector) whose components are respectively set such that Dᵢ=d/dᵢ or Vᵢ=(d/dᵢ)·vᵢ. More specifically, the ciphertext is created by a product-sum operation result of the components of the third vector (extended plaintext vector) and the components of the public-key vector modulo-transformed based on one or a plurality of fourth vector (base vector), or by a remainder formed by dividing the product-sum operation result by a modulus.

Moreover, the positions of the components of the plaintext vector as a plaintext portion which is intended to be encrypted or the positions to which the components of the random number vector as a redundant portion (reduced portion) are not fixed, and can be arbitrarily set by an entity as the sender or an entity as the receiver. Accordingly, since the position of the plaintext portion or a position to which the redundant portion (reduced portion) is added is not fixed and is arbitrarily set, such a position is not known by the attacker, thereby further improving the security.

Furthermore, information indicating this set position may be transmitted publicly or secretly from an entity who set the position to the other entity. In the case where an entity as the sender sets the position, the information indicating the set position may be sent to an entity as the receiver together with the ciphertext by including this information in the ciphertext, or sent to the entity as the receiver via a course different from the transmission of the ciphertext.

More specifically, in the case where the information indicating the set position is sent by including the information in the ciphertext, the ciphertext is created using a publicized fifth vector (public-key vector) and a fourth vector (extended plaintext vector) formed by combining a first vector (plaintext vector) obtained by dividing plaintext to be encrypted, a second vector (pseudo plaintext vector) consisting of random number components which have no need of transmission of information particularly and a third vector (position indicating vector) indicating the positions of the components of the first vector or the second vector. More specifically, the ciphertext is created by a product-sum operation result of the components of the fourth vector (extended plaintext vector) and the components of the fifth vector (public-key vector) modulo-transformed based on one or a plurality of sixth vector (base vector), or by a remainder formed by dividing the product-sum operation result by a modulus. In this case, the positions of the components of the third vector are publicized. This positional information is included as the third vector (position indicating vector) in the ciphertext and transmitted to the entity as the receiver. Since the position of each component of the third vector is publicized, the entity as the receiver can decrypt the components of the third vector, know the positions of the components of the first vector (plaintext vector) based on the decryption result, and decrypt the ciphertext into the plaintext.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic diagram showing a communication state of information between two entities; and

FIG. 2 is an illustration showing the structures of embodiments of a recording medium.

### DETAILED DESCRIPTION OF THE INVENTION

The present invention will be described in detail below with reference to the drawings illustrating some embodiments thereof.

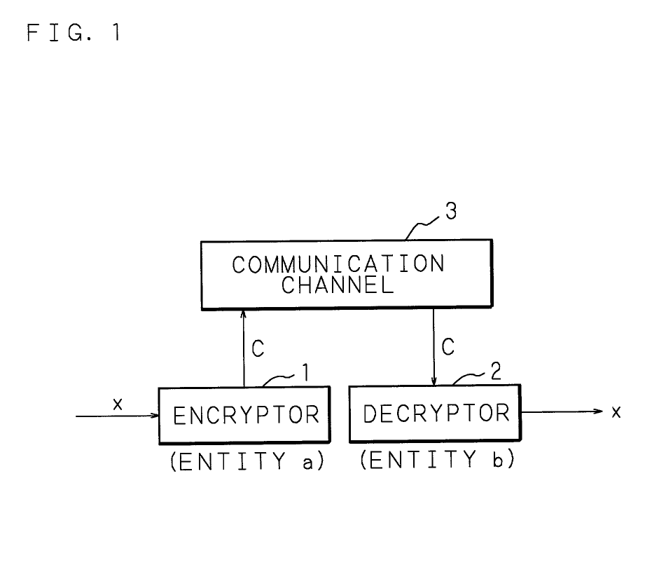

FIG. 1 is a schematic diagram showing a state in which an encryption method according to the present invention is used for information communication between entities a and b. FIG. 1 shows an example in which one of the entities, a, encrypts plaintext x into ciphertext C by an encryptor 1 and transmits the ciphertext C to the other entity, b, through a communication channel 3, and the entity b decrypts the ciphertext C into the original plaintext x by a decryptor 2.

(First Embodiment)

The secret key and public key are prepared as follows.

Secret key: {dᵢ}, {dᵢ′}, {vᵢ}, P, w

Public key: {cᵢ}

Let e>e′, the normal bases dᵢ and reduced bases dᵢ′ are defined as the bases satisfying (1) and (2), respectively.

dᵢ=2^{e}+δᵢ(1<<δᵢ<<2^{e}) (1)

dᵢ′=2^{e′}+δᵢ′(1<<δᵢ′>>2^{e′}) (2)

(k+n) bases consisting of mutually prime numbers are determined. Here, among them, k bases corresponding to i∈I are normal bases, and n bases corresponding to i∈I′ are reduced bases. Here, each of I and I′ is an index-set, I={1, 2, . . . , k}, I′={k+1, k+2, . . . , k+n}, and I″=I∪I′. Note that, in the first and second embodiments, unless otherwise specified, i⊂I″. Next, a base-product Dᵢ is calculated according to (3) below.

$${D}_{i} = \{ \begin{matrix}\frac{{d}_{1} … {d}_{k} {d}_{k + 1}^{′} … {d}_{k + n}^{′}}{di} ( i ∈ I ) \\ \frac{{d}_{1} … {d}_{k} {d}_{k + 1}^{′} … {d}_{k + n}^{′}}{{di}^{′}} ( i ∈ {I}^{′} )\end{matrix} \qquad ( 3 )$$

Moreover, (k+n) random numbers {vᵢ} (where gcd(dᵢ, vᵢ)=1) are generated, and a transformed base-product Vᵢ is calculated by (4) below.

Vᵢ=Dᵢvᵢ (4)

The entity a divides the plaintext x, which is to be encrypted and transmitted to the entity b, into k parts so as to obtain a plaintext vector g=(g₁, g₂, . . . , gₖ) whose components are respectively e bits. Further, a pseudo plaintext vector g′=(gₖ₊₁, gₖ₊₂, . . . , gₖ₊ₙ) whose components are respectively e-bit random numbers, which needs not to be particularly transmitted to the entity b, is obtained. For example, this pseudo plaintext vector g′ can be obtained by dividing plaintext (redundant text) which need not to be particularly transmitted to the entity b into n parts. By coupling these plaintext vector g and pseudo vector g′, an extended plaintext vector g″=(g₁″, g₂″, . . . , gₖ₊ₙ″) having (k+n) components is obtained. Here, the components of this extended plaintext vector g″ are respectively defined as shown in (5) below.

$${g}_{i}^{″} = \{ \begin{matrix}{g}_{i} & ( i ∈ I ) \\ {g}_{i}^{′} & ( i ∈ {I}^{′} )\end{matrix} \qquad ( 5 )$$

With the use of the extended plaintext vector g″ and the transformed base-product Vᵢ, the product-sum plaintext M is defined as shown in (6) below.

M=g₁″V₁+g₂″V₂+ . . . +gₖ₊ₙ″Vₖ₊ₙ (6)

For any extended plaintext vector g″, a prime number P satisfying M<P is generated and used as a modulus. A random number w smaller than the prime number P is determined, and a public-key vector c as shown in (8) below is obtained according to (7) below and publicized.

Cᵢ=wVᵢ mod P (7)

vector c=(c₁, c₂, . . . , cₖ₊ₙ) (8)

The entity a calculates the inner-product of the extended plaintext vector g″ and the public-key vector c as shown in (9) below to obtain the ciphertext C. The created ciphertext C is transmitted from the entity a to the entity b through the communication channel 3.

C=g₁″c₁+g₂″+c₂+ . . . +gₖ₊ₙ″Cₖ₊ₙ (9)

The entity b performs the decryption process as follows.

From the ciphertext C, the product-sum plaintext M can be computed as shown in (10) below.

M=w⁻¹C mod P (10)

In the extended plaintext vector g″, for the indexes corresponding to the normal bases, i.e., i∈I, (11) shown below is established, thereby enabling decryption of the plaintext vector g.

gᵢ=MVᵢ⁻¹ mod dᵢ (11)

Besides, for the indexes corresponding to the reduced bases, i.e., i∈I′, decryption is not necessary. Further, even when an attempt to perform decryption according to (12) below is made in the same manner as in (11) above, since there is a relationship shown in (13) below in the number of bits due to the effect of reduction, the pseudo plaintext vector g′ can not be accurately decrypted.

gᵢ′″=MVᵢ⁻¹ mod dᵢ′ (12)

gᵢ′>dᵢ′>dᵢ′″ (13)

Note that, while gcd(Vᵢ, dᵢ)=1 in the above example, it is also possible to make gcd(Vᵢ, dᵢ)=Aᵢ. In this case, the processes are performed in the same manner by letting Vᵢ′=Vᵢ/Aᵢ, dᵢ′=dᵢ/A_{i,} and gcd(Vᵢ′, dᵢ′)=1. Furthermore, in the above example, while random numbers {Vᵢ} are added to the base-product Dᵢ, the base-product Dᵢ shown in (3) above may be used as it is without adding such random numbers.

(Second Embodiment)

The secret key and public key are prepared as follows.

Secret key: {dᵢ^{(P)}}, {dᵢ^{(Q)}}, {dᵢ^{(P)′}}, {dᵢ^{(Q)′}}, {vᵢ^{(P)}}, {vᵢ^{(Q)}}, P, Q, N, w

Public key: {cᵢ} Note that, N may be publicized.

Let P and Q be prime numbers satisfying the conditions described later. Let e>e′, the normal bases dᵢ^{(P)}, dᵢ^{(Q)} and the reduced bases dᵢ^{(P)}′, dᵢ^{(Q)}′ are defined as the bases satisfying (14) and (16), respectively.

dᵢ^{(P)}dᵢ^{(Q)}=2^{e}+δᵢ(1<<δᵢ<<2^{e}) (14)

dᵢ^{(P)′}dᵢ^{(Q)′}=2^{e′}+δᵢ′(1<<δᵢ′<<2^{e′}) (15)

For the modulus P and modulus Q, like the first embodiment, two sets of bases {dᵢ^{(P)}}, {dᵢ^{(P)′}} and {dᵢ^{(Q)}}, {dᵢ^{(Q)′}} (where, when i ≠ j, gcd(dᵢ^{(P)}dⱼ^{(P)})=1 and gcd(dᵢ^{(Q)}dⱼ^{(Q)})=1) are generated. Here, (16) and (17) shown below are satisfied for any i∈I″.

gcd(dᵢ^{(P)}, dᵢ^{(Q)})=1 (16)

gcd(dᵢ^{(P)′}, dᵢ^{(Q)′})=1 (17)

Next, for the modulus P and modulus Q, like the first embodiment, two sets of random numbers {vᵢ^{(P)}} and {vᵢ^{(Q)}} (where gcd(dᵢ^{(P)}, vᵢ^{(P)})=1, gcd(dᵢ^{(Q)}, vᵢ^{(Q))=}1) are generated, and {Vᵢ^{(P)}} and {Vᵢ^{(Q)}} are given by calculations similar to (3) and (4) shown above.

For the extended plaintext vector g″ constructed in the exactly same manner as in the first embodiment, the product-sum plaintext M_{P} and the product-sum plaintext M_{Q} in modulo P and modulo Q are defined as (18) and (19), respectively.

M_{P}=g₁″V₁^{(P)}+g₂″V₂^{(P)}+ . . . +gₖ₊ₙ″Vₖ₊ₙ^{(P)} (18)

M_{Q}=g₁″V₁^{(Q)}+g₂″V₂^{(Q)}+ . . . +gₖ₊ₙ″Vₖ₊ₙ^{(Q)} (19)

Furthermore, the prime numbers P and Q are generated to satisfy the conditions M_{P}<P and M_{Q}<P for any extended plaintext vector g″, and the product of them are defined as N. A minimum V₁^{(N)}(<N) which causes the remainders by P and Q to be V₁^{(P)} and V₁^{(Q)}, respectively, is calculated using the Chinese Remainder Theorem, and defined as the transformed base-product.

With the use of the extended plaintext vector g″ and the transformed base-product V₁^{(N)}, the product-sum plaintext M is defined as shown in (20) below. Here, it is not necessary to satisfy M<N.

M=g₁″V₁^{(N)}+g₂″V₂^{(N)}+ . . . +gₖ₊ₙ″Vₖ₊ₙ^{(N)} (20)

A random number w smaller than N is determined, and the public-key vector c as shown in (22) below is obtained according to (21) below and publicized.

cᵢ=wVᵢ mod N (21)

vector c=(cᵢ, c₂, . . . , cₖ₊ₙ) (22)

The entity a calculates the inner-product of the extended plaintext vector g″ and the public-key vector c as shown in (23) below to obtain the ciphertext C. The created ciphertext C is transmitted from the entity a to the entity b through the communication channel 3. Besides, in the case where N is publicized, the remainder formed by dividing the C shown in (23) below by N is made the ciphertext.

C=g₁″c₁+g₂″+c₂+ . . . +gₖ₊ₙ″cₖ₊ₙ (23)

The entity b performs the decryption process as follows.

The product-sum plaintext M satisfies (24) below. Therefore, the product-sum plaintext M_{P} and M_{Q} in modulo P and modulo Q can be computed as shown in (25) and (26) below.

M≡w⁻¹C(mod N) (24)

M_{P}=M mod P (25)

M_{Q}−M mod Q (26)

In the extended plaintext vector g″, for the indexes corresponding to the normal bases, i.e., i∈I, since 2^{e}<dᵢ^{(P)}dᵢ^{(Q)}, (gᵢ^{(P)}, gᵢ^{(Q)}) are calculated by (27) and (28) below, and (29) shown below is established using the Chinese Remainder Theorem, thereby enabling decryption of the plaintext vector g.

gᵢ^{(P)≡}M_{P}Vᵢ^{(P)-1}(mod dᵢ^{(P)}) (27)

gᵢ^{(Q)≡}M_{Q}Vᵢ^{(Q)-1}(mod dᵢ^{(Q)}) (28)

$${g}_{i} ≡ \{ \begin{matrix}{{g}_{i}}^{( P )} ( mod {{d}_{i}}^{( P )} ) \\ {{g}_{i}}^{( Q )} ( mod {{d}_{i}}^{( Q )} )\end{matrix} \qquad ( 29 )$$

Besides, for the indexes corresponding to the reduced bases, i.e., i∈I′, like the first embodiment, decryption is not necessary and the pseudo plaintext vector g′ can not be accurately decrypted.

Note that, in the above example, while the random numbers {vᵢ^{(P)}}, {vᵢ^{(Q)}} are added to two sets of bases {dᵢ^{(P)}}, {dᵢ^{(Q)}}, a base-product obtained without adding such random numbers may be used.

Next, the following description will explain that a high density exceeding 1 is realized by the schemes as described in the first and second embodiments so as to have a strong resistance to the low-density attack based on the LLL algorithm. For a general product-sum type cryptosystem that is not reduced, the ciphertext density σ, the scheme density ρ, and the rate η are respectively defined as shown in (30), (31), and (32) below. Note that C is the number of bits of the ciphertext, Cₘₐₓ is the possible maximum number of bits of the ciphertext, k is the number into which the plaintext is divided, and e is the number of bits of the divided plaintext.

$$\begin{matrix}σ = \frac{{\sum }_{i = 1}^{k} {log}_{2} {g}_{i}}{{log}_{2} C} & ( 30 ) \\ ρ = \frac{ke}{{log}_{2} {C}_{max}} & ( 31 ) \\ η = \frac{ke}{\vert {C}_{max} \vert} & ( 32 )\end{matrix}$$

Further, for a product-sum type cryptosystem that is reduced like the first and second embodiments, the ciphertext density σ and the scheme density ρ′ are respectively defined as shown in (33) and (34) below. Note that the rate is the same as (32) above.

$$\begin{matrix}{σ}^{′} = \frac{{\sum }_{i = 1}^{k + n} {log}_{2} {g}_{i}^{″}}{{log}_{2} C} & ( 33 ) \\ {ρ}^{′} = \frac{( k + n ) e}{{log}_{2} {C}_{max}} & ( 34 )\end{matrix}$$

The density in the first embodiment will be considered. Let the random number vᵢ be s bits. In order to make the density as large as possible, when the possible maximum product-sum plaintext is denoted as Mₘₐₓ, the bit-size of the modulus P should be set such that |P|=|Mₘₐₓ|. In this case, the scheme density ρ₁ and the rate η₁ according to the first embodiment satisfy the conditions of (35) and (36), respectively.

$$\begin{matrix}\begin{matrix}{ρ}_{1} = \frac{( k + n ) e}{e + {log}_{2} P + {log}_{2} ( k + n )} > \\ \frac{( k + n ) e}{( k + 2 ) e + ( n - 1 ) {e}^{′} + s + 2 {log}_{2} ( k + n ) + 1}\end{matrix} & ( 35 ) \\ \begin{matrix}{η}_{1} = \frac{ke}{e + {log}_{2} P + {log}_{2} ( k + n )} > \\ \frac{ke}{( k + 2 ) e + ( n - 1 ) {e}^{′} + s + 2 {log}_{2} ( k + n ) + 1}\end{matrix} & ( 36 )\end{matrix}$$

In order to avoid attacks for finding the secret key from the public key (Kiyoko Katayanagi, Yasuyuki Murakami, Masao Kasahara: “Study on the product-sum type cryptosystem”, reference material in The 1999 Symposium on Cryptography and Information Security, disclosed in B43 January 2000), the bit-size of the random number vᵢ needs to be ¼ or more of the bit-size of the modulus P. In order to satisfy this condition, when calculation is performed by supposing that the bit-size of the random number vᵢ is s=(¼)log₂P+1, the scheme density ρ₁ and the rate η₁ satisfy the conditions of (37) and (38), respectively.

$$\begin{matrix}{ρ}_{1} > \frac{3 ( k + n ) e}{( 4 k + 7 ) e + 4 ( n - 1 ) {e}^{′} + 7 {log}_{2} ( k + n ) + 7} & ( 37 ) \\ {η}_{1} > \frac{3 ke}{( 4 k + 7 ) e + 4 ( n - 1 ) {e}^{′} + 7 {log}_{2} ( k + n ) + 7} & ( 38 )\end{matrix}$$

In this condition, since the random number vᵢ is extremely large, if the condition e′<e/2 or k<n is met, a parameter satisfying ρᵢ>1 exists.

The density in the second embodiment will be considered. Let the product of the random numbers vᵢ^{(P)} and vᵢ^{(Q)}, i.e., vᵢ^{(P)}vᵢ^{(Q)}, be s bits. When a modulus N is not publicized, in order to make the density as large as possible, if the possible maximum product-sum plaintext is denoted by M_{Pmax} and M_{Qmax}, then the bit-size should be set such that |P|=|M_{Pmax}|, |Q|=|M_{Qmax}|. In this case, the scheme density ρ₂ and the rate η₂ according to the second embodiment satisfy the conditions of (39) and (40), respectively.

$$\begin{matrix}\begin{matrix}{ρ}_{2} = \frac{( k + n ) e}{e + {log}_{2} N + {log}_{2} ( k + n )} > \\ \frac{( k + n ) e}{( k + 3 ) e + ( n - 1 ) {e}^{′} + s + 3 {log}_{2} ( k + n ) + 1}\end{matrix} & ( 39 ) \\ \begin{matrix}{η}_{2} = \frac{ke}{e + {log}_{2} N + {log}_{2} ( k + n )} > \\ \frac{Ke}{( k + 3 ) e + ( n - 1 ) {e}^{′} + s + 3 {log}_{2} ( k + n ) + 1}\end{matrix} & ( 40 )\end{matrix}$$

In the second embodiment, since multiplexing is employed, it is not necessary to make the random numbers very large. Therefore, even when the conditions are e′=e/2 and k=n, it is possible to readily achieve the scheme density ρ₂>1 and the rate η₂>½. For example, in the above conditions, when the divided number is k=8 and each of the bases dᵢ^{(P)}, dᵢ^{(Q)} and the random numbers vᵢ^{(P)}, vᵢ^{(Q)} is 32 bits, η₂=1.0174, η₂=0.5087, and thus the above conditions (ρ₂>1, η₂>½) are realized with such small parameters. However, there is a security problem with small parameters, and therefore it is practical to use parameters of, for example, around k=100, e=64, and e′=32.

Moreover, when the modulus N is publicized and the remainder of dividing C by N is made the ciphertext, the scheme density ρ₂ and the rate η₂ according to the second embodiment respectively satisfy the conditions of (41) and (42) below.

$$\begin{matrix}\begin{matrix}{ρ}_{2} = \frac{( k + n ) e}{{log}_{2} N} > \\ \frac{( k + n ) e}{( k + 2 ) e + ( n - 1 ) {e}^{′} + s + 2 {log}_{2} ( k + n ) + 1}\end{matrix} & ( 41 ) \\ \begin{matrix}{η}_{2} = \frac{ke}{{log}_{2} N} > \\ \frac{Ke}{( k + 2 ) e + ( n - 1 ) {e}^{′} + s + 2 {log}_{2} ( k + n ) + 1}\end{matrix} & ( 42 )\end{matrix}$$

As described above, when the modulus N is publicized, both of the scheme density ρ₂ and the rate η₂ are improved as compared with those when the modulus N is not publicized.

By the way, it is possible to set the random number components in the pseudo plaintext vector g′ completely independently of the plaintext vector g. Therefore, the random number components of the pseudo plaintext vector g′ can be set so that the scheme density of the created ciphertext C becomes higher. Moreover, there is an effective technique in which, after creating the ciphertext C by setting a certain random number sequence as the pseudo plaintext vector g′, the scheme density of the ciphertext C is calculated and, when the calculated value does not exceed 1, the ciphertext C is recreated by setting a different random number sequence for the pseudo plaintext vector g′, or, when the scheme density exceeds 1, the ciphertext C is transmitted to the entity as the receiver.

In the schemes of the above-described first and second embodiments, the positions (reduced positions) of the random numbers of the pseudo plaintext vector, which need not to be particularly encrypted and transmitted to the entity b, in the extended plaintext vector are fixedly set by the entity b as the receiver, and information indicating the positions is publicized.

On the other hand, if the positions (reduced positions) of such random number components or positions (normal positions) of the components of the plaintext vector to be encrypted can be arbitrarily set, a further improvement in security can be expected. The third embodiment given below explains the case where such reduced positions or normal positions are arbitrarily set by the entity a as the sender and the ciphertext including therein the information indicating the positions is transmitted to the entity b.

(Third Embodiment)

First, some definitions used for explaining the third embodiment will be described. In the third embodiment, the plaintext to be encrypted is also divided into some divided plaintext. Each divided plaintext is treated as a message vector m′. The message vector m is extended into a vector m′ by extension-transformation to be defined below. This vector m′ is referred to as the “extension message vector”. The sum of the bit-size of the components of these vector m and vector m′ is ε (bits) and ε′ (bits), respectively (where ε≧ε′). Moreover, let the possible maximum bit number of the ciphertext be Cₘₐₓ.

<Definition 1 (Density)>

The scheme density ρ is defined as shown in (43) below.

$$ρ = \frac{{ϵ}^{′}}{{log}_{2} {C}_{max}} \qquad ( 43 )$$

Definition 2 (Rate)>

The rate η is defined as shown in (44) below.

$$η = \frac{ϵ}{\vert {C}_{max} \vert} \qquad ( 44 )$$

Let the vector a=(a₁, a₂, . . . , a_{w}) be a w-dimensional vector and the vector c=(c₁, c₂, . . . , cₙ) be an n-dimensional vector. Moreover, let the vector b=(b₁, b₂, . . . , bₙ) be an n-dimensional binary vector of weight w. Here, the conditions shown in (45) below are satisfied.

$$\begin{matrix}{b}_{{i}_{1}} = {b}_{{i}_{2}} = … = {b}_{{i}_{w}} = 1 \\ {i}_{1} < {i}_{2} < … < {i}_{w}\end{matrix} \} \qquad ( 45 )$$

<Definition 3 (Index-Set)>

The index-set I=Ind(vector b) is defined as shown in (46) below.

I={(i₁, i₂, . . . , i_{w})} (46)

<Definition 4 (Vector Expression)>

The index-set I is a subset of {1, 2, . . . , n}, and the vector d=Vec(I, n) is defined as a vector expression as shown in (47) below. Here, the vector d=(d₁, d₂, . . . , dₙ), and, for example, when I=Ind(vector b), vector b=Vec(I, n).

$${d}_{i} \{ \begin{matrix}1 & ( i ∈ I ) \\ 0 & ( i ∉ I )\end{matrix} \qquad ( 47 )$$

<Definition 5 (Extension)>

The n-dimensional vector c extended from the vector a by the vector b is expressed as vector c=vector a{vector b}, and defined as shown in (48) below. For example, if vector a=(a₁, a₂, a₃) and vector b=(1, 0, 1, 1), then vector a{vector b}=(a₁, 0, a₂, a₃).

$$\{ \begin{matrix}{c}_{{i}_{j}} = {a}_{j} & \\ {c}_{k} = 0 & ( in case of {b}_{k} = 0 )\end{matrix} \\ ( j = 1 , 2 , … , w , k = 1 , 2 , … , n ) \qquad ( 48 )$$

<Definition 6 (Extraction)>

The w-dimensional vector a extracted from the vector c by the vector b is expressed as vector a=vector c{vector b}, and defined as shown in (49) below. For example, if vector c=(c₁, c₂, c₃, c₄) and vector b=(1, 0, 1, 1), then the first, third and fourth components are extracted, so that vector c{vector b}=(c₁, c₃, c₄).

\vec{a}=(cᵢ_{₁}, cᵢ_{₂}, . . . , cᵢ_{_{w}}) (49)

Next, a specific scheme of the third embodiment will be explained.

<Dividing Plaintext>

The plaintext x is divided into a plurality of ek-bit blocks. Each block is expressed by the message vector m as shown in (50) below. Note that mᵢ(i=1, 2, . . . , k) are e-bit integers.

vector m=(m₁, m₂, . . . , mₖ) (50)

<Extension Transformation>

Let the message vector m be a k-dimensional vector whose components are e-bit integers and the random number vector r be an n-dimensional vector whose components are e′-bit integers. Here, e<e′. Moreover, let a vector s be a (k+n)-dimensional binary vector of weight k. This vector s will be referred to as the “position indicator”.

Set h as shown in (51) below and let a vector s′ be an arbitrary (he-(k+n))-bit binary padding vector. An he-dimensional binary concatenate vector [vector s|vector s′] can be divided into h-dimensional vectors t whose components are e-bit integers as shown in (52) below.

h=┌(k+n)/e┐ (51)

\vec{t}=(t₁, t₂. . . , tₕ) (52)

Let K=k+n+h, and the index-sets I_{N}, I_{R} and I_{L} are respectively defined as shown in (53), (54) and (55) below. Here, a vector s bar represents a bit complement of the vector s.

I_{N}=Ind(\vec{s}) (53)

I_{R}=Ind(\vec{s}) (54)

I_{L}={k+n+1, k+n+2, . . . , K} (55)

Note that while the components of the index-set I_{L} are the last h components in the above example, the location of these components may be decided arbitrarily. In this case, the conditions of (56) and (57) below are satisfied, and the vector m′ and vector s are respectively expressed as shown in (58) and (59) below.

I_{N}∪I_{R}∪I_{L}={1, 2, . . . , K} (56)

I_{N}∩I_{R}=I_{R}∩I_{L}=I_{L}∩I_{N}=φ (57)

\vec{m′}=\vec{m}={Vec(I_{N}, K)}+\vec{r}{Vec(I_{R}, K)}+\vec{t}{Vec(I_{L}, K)} (58)

\vec{s}=Vec(I_{N}, K) [\overline{Vec(I_{L}, K)}] (59)

The message vector m is transformed into the extension message vector m′=(m₁′, m₂′, . . . , mₖ′) as shown in (60) below. In this case, each component of this vector m′ has a size shown in (61) below.

\vec{m′}=[\vec{m}{\vec{s}}+\vec{r}{\vec{s}}|\vec{t}] (60)

$$\vert {m}_{i}^{′} \vert = \{ \begin{matrix}e & ( i ∈ {I}_{N} ⋃ {I}_{L} ) \\ {e}^{′} & ( i ∈ {I}_{R} )\end{matrix} \qquad ( 61 )$$

<Key Generation>

The secret key and public key are prepared as follows.

Secret key: {dᵢ^{(P)}}, {dᵢ^{(Q)}}, {vᵢ^{(P)}}, {vᵢ^{(Q)}}, P, Q, N, w (where i=1, 2, . . . , K)

Public-key vector c=(c₁, c₂, . . . , cₖ), I_{L}, e, e′ Note that, the N may be publicized.

First, for any i and j (where I≠j), two sets of bases {dᵢ^{(P)}}, {dᵢ^{(Q)}} satisfying the conditions shown in (62) to (65) below are generated.

gcd(dᵢ^{(P)}, dⱼ^{(P)})=1 (62)

gcd(dᵢ^{(Q)}, dⱼ^{(Q)})=1 (63)

gcd(dᵢ^{(P)}, dᵢ^{(Q)})=1 (64)

dᵢ^{(P)}dᵢ^{(Q)}=2^{e}+δᵢ(1<<δᵢ<<2^{e}) (65)

Let vᵢ^{(P)}, vᵢ^{(Q)} be randomly selected integers, and Vᵢ^{(P)}, Vᵢ^{(Q)} are calculated as shown in (66) and (67) below. Here, vᵢ^{(P)} and vᵢ^{(Q)} satisfy the conditions shown in (68) and (69) below.

$$\begin{matrix}{{V}_{i}}^{( P )} = \frac{{{d}_{1}}^{( P )} {{d}_{2}}^{( P )} … {{d}_{k}}^{( P )}}{{{d}_{i}}^{( P )}} {{v}_{i}}^{( P )} & ( 66 ) \\ {{V}_{i}}^{( Q )} = \frac{{{d}_{1}}^{( Q )} {{d}_{2}}^{( Q )} … {{d}_{k}}^{( Q )}}{{{d}_{i}}^{( Q )}} {{v}_{i}}^{( Q )} & ( 67 )\end{matrix}$$

gcd(dᵢ^{(P)}, vᵢ^{(P)})=1 (68)

gcd(dᵢ^{(Q)}, vᵢ^{(Q)})=1 (69)

Next, for any extension message vector m′, large prime numbers P and Q satisfying the conditions M_{P}<P, M_{Q}<Q are set. Note that M_{P} and M_{Q} are respectively defined as shown in (70) and (71) below.

M_{P}=m′₁V₁^{(P)}+m′₂V₂^{(P)}+ . . . +m′_{K}V_{K}^{(P)} (70)

M_{Q}=m′₁V₁^{(Q)}+m′₂V₂^{(Q)}+ . . . +m′_{K}V_{K}^{(Q)} (71)

Then, set N=PQ, and calculate Vᵢ(0≦Vᵢ<N) by (72) shown below according to the Chinese Remainder Theorem.

$${V}_{i} = \{ \begin{matrix}{{V}_{i}}^{( P )} & ( mod P ) \\ {{V}_{i}}^{( Q )} & ( mod Q )\end{matrix} \qquad ( 72 )$$

Each component of the public-key vector c is computed by (73) shown below. Here, w is a random number arbitrarily selected from Zₙ*.

Cᵢ=wVᵢ mod N (73)

<Encryption>

The entity a (sender) arbitrarily generates the vector s as the above-described position indicator. In other words, the entity a as the sender arbitrarily selects an index-set I_{N} that indicates the location related to the message vector m. Next, the entity a (sender) generates an n-dimensional vector r whose components are arbitrarily selected e′-bit integers. A high density is realized by this random number vector r. In other words, by adding the random number vector r as a redundant portion (reduced portion), the density becomes higher as to be described later.

The entity a (sender) transforms the message vector m into the extension message vector m′ by the vector s and vector r. Then, the inner-product of-.this extension message vector m′ and the public-key vector c is calculated as shown in (74) below to obtain the ciphertext C. The created ciphertext C is transmitted from the entity a to the entity b through the communication channel 3.

$$\begin{matrix}C = \vec{{m}^{′}} \cdot \vec{c} \\ = {m}_{1}^{′} {c}_{1} + {m}_{2}^{′} {c}_{2} + … + {m}_{k}^{′} {c}_{k}\end{matrix} \qquad ( 74 )$$

In this encryption, the message vector m obtained by dividing the plaintext to be encrypted is transmitted at the positions indicated by the index-set I_{N}, and the information about the index-set I_{N} is transmitted by the vector s at the positions indicated by the index-set I_{L}.

<Decryption>

The entity b (receiver) performs the decryption process as follows.

The intermediate massage M satisfies (75) shown below. Therefore, the intermediate messages M_{P}, M_{Q} in modulo P and modulo Q can be computed as shown in (76) and (77) below.

M≡w⁻¹C(mod N) (75)

M_{P}=M mod P (76)

M_{Q}=M mod Q (77)

Then, (mᵢ^{(P)}, mᵢ^{(Q)}) are obtained by (78) and (79) below, and (80) shown below is established by applying the Chinese Remainder Theorem, thereby enabling decryption of the message vector m″=(m₁″, m₂″, . . . , mₖ″).

mᵢ^{(P)}≡M_{P}Vᵢ^{(P)}^{⁻¹}(mod dᵢ^{(P)}) (78)

mᵢ^{(Q)}≡M_{Q}Vᵢ^{(Q)}^{⁻¹}(mod dᵢ^{(Q)}) (79)

$${m}_{i}^{″} ≡ \{ \begin{matrix}{m}_{i}^{( P )} ( mod {d}_{i}^{( P )} ) \\ {m}_{i}^{( Q )} ( mod {d}_{i}^{( Q )} )\end{matrix} \qquad ( 80 )$$

Since e′>e, from (61) above, each component of the decrypted message vector m″ satisfies the conditions shown in (81) below.

$$\{ \begin{matrix}{m}_{i}^{″} = {m}_{i}^{′} & ( i ∈ {I}_{N} ⋃ {I}_{L} ) \\ {m}_{i}^{″} \neq {m}_{i}^{′} & ( i ∈ {I}_{R} )\end{matrix} \qquad ( 81 )$$

According to the index-set I_{L}, the vector t is extracted from the decrypted vector m″ as shown in (82) below.

$$\vec{t} = \vec{{m}^{″}} [ Vec ( {I}_{L} , K ) ] \qquad ( 82 )$$

By regarding the vector t as the he-dimensional binary vector [vector s|vector s′], the entity b (receiver) can rebuilt the (k+n)-dimensional binary vector s of weight k. It is therefore possible to finally obtain the message vector m as shown in (83) below.

$$\vec{m} = \vec{{m}^{″}} [ \vec{s} ] \qquad ( 83 )$$

Note that, in a general case where the components of the index-set I_{L} are arbitrarily selected, by substituting the vector m″ in (83) above with one shown in (84) below, the message vector m is obtained.

$$\vec{{m}^{″}} [ \overline{Vec ( {I}_{L} , K )} ] \qquad ( 84 )$$

Next, the security of the encryption scheme of the third embodiment as described above will be explained. It has been known that the low-density attack using the LLL algorithm is a very effective attack method with respect to the product-sum type public-key cryptosystems when the density is small. For example, it has also been known that the knapsack cryptosystem which is a typical one of the product-sum type cryptosystems is broken by the low-density attack when the density is smaller than 0.9408. In the encryption scheme of the above-described third embodiment, a high density exceeding 1 is realized, which means that this scheme is safe from the low-density attack.

If each of the random numbers vᵢ^{(P)}, vᵢ^{(Q)} is an f-bit number, the density ρ in the above-described encryption scheme of the third embodiment satisfies the condition shown in (85) below. Here, K=k+n+h, and e′>e.

$${m}_{i}^{″} ≡ \{ \begin{matrix}{{m}_{i}}^{( P )} & ( mod {{d}_{i}}^{( P )} ) \\ {{m}_{i}}^{( Q )} & ( mod {{d}_{i}}^{( Q )} )\end{matrix} \qquad ( 80 )$$

For example, when f=e and e′=2e are set for simplicity, since n satisfies the condition shown in (86) below, ρ>1 is realized. As a practical example, when e=32, it will be understood that ρ>1 can be realized by making n=7 for all k.

(n−6)e>3 log₂ n+1 (86)

Moreover, in the encryption scheme of the third embodiment, a high rate can also be realized. The rate η in the above-described encryption scheme of the present invention satisfies the condition shown in (87) below.

$$η = \frac{ke}{⌈ {e}^{′} + {log}_{2} N + {log}_{2} n ⌉} > \frac{ke}{Ke + ( 3 {e}^{′} - e ) + f + 1 + 3 {log}_{2} n} \qquad ( 87 )$$

Here, when f=e and e′=2e are set for simplicity, since n and k satisfy the condition shown in (88) below, η>0.5 is realized. As a practical example, when e=32, it will be understood that η>0.5 can be realized by making n=7 and k>14. For instance, if k=57, then η≈0.7884. Thus, from the viewpoint of the rate, the scheme of the third embodiment is efficient.

$$( k - n - ⌈ \frac{k + n}{3} ⌉ - 6 ) e > 3 {log}_{2} n + 1 \qquad ( 88 )$$

Since the encryption scheme of the third embodiment can realize a high density, it is sufficiently safe from the low-density attack. Moreover, the entity as the sender can freely decide the positions of reduced bases. Therefore, even if the attacker tries to make an effective attack on the encryption scheme of the third embodiment based on the reduced bases whose positions are known, it is difficult for the attacker to identify the positions of the reduced bases. Accordingly, the characteristic feature of the third embodiment that the positions of the reduced bases are not fixed and can be arbitrarily decided by the sender means that this scheme is also safe from attacks which are effective when the positions of the reduced bases are known.

The following description will explain other examples of the third embodiment. In the above-described example, while the location of I_{L} is fixed (the last end) in every block, the location of this I_{L} may be different between the respective blocks. As such an example, the following are given.

### FIRST EXAMPLE

For the first block, the location of I_{L} is fixed (for example, at the last end like the above-mentioned example), and this I_{L} is publicized. Then, for the second block and following blocks, the location of I_{L} in each block is decided by the message vector of a block that comes one block before. Therefore, the location of I_{L} varies from the second block. Accordingly, even when the entity as the sender arbitrarily decides the positions of the reduced bases, since the I_{L} in the first block is publicized and the location of I_{L} in the second block and the following blocks is known from the message vectors of the previous blocks, the entity as the receiver can decrypt the ciphertext into the plaintext like the above-mentioned example. In this first example, since the location Of I_{L} is varied in each block, it is possible to achieve an improvement in the security.

### SECOND EXAMPLE

For the first block, the position of I_{L} is fixed (for example, at the last end like the above-mentioned example), and this I_{L} is publicized. Then, for the second block and the following blocks, the term of I_{L} is not provided, and the h-dimensional vector to be allocated to the term of I_{L} is allocated to a message obtained by dividing the plaintext. Then, for the second block and the following blocks, the positional information indicating the positions of the reduced bases of each block is decided from the message of a block that comes one block before. Therefore, I_{L} does not exist in the second block and the following blocks. Accordingly, even when the entity as the sender arbitrarily decides the positions of the reduced bases, since the I_{L} in the first block is publicized and the positions of the reduced bases in the second block and the following blocks are known from the message vectors of the previous blocks, the entity as the receiver can decrypt the ciphertext into the plaintext like the above-mentioned example. Moreover, in the second block and the following blocks, since portions to be allocated to the message is increased from k terms to (k+h) terms, the volume of message that can be included in a single block is increased, thereby enabling a further increase in the rate.

Note that, in the above example, while the information (index-set I_{L}) indicating the positions (index-set I_{N}) of the components of the message vector m obtained by dividing the plaintext to be encrypted is transmitted, it is certainly possible to transmit information indicating the positions (index-set I_{R}) of the components of the random number vector r to be added.

Moreover, in the above example, while the random numbers {vᵢ^{(P)}}, {vᵢ^{(Q)}} are added to two sets of bases {dᵢ^{(P)}}, {dᵢ^{(Q)}}, it is also possible to use a base-product obtained without adding such random numbers.

Furthermore, in the above example, as shown in (74), the inner-product value (product-sum operation result) of the extension message vector m′ and the public-key vector c is made the ciphertext C as it is, but one obtained by transformation of the inner-product value (product-sum operation result) modulo N, i.e., the remainder formed by dividing C in the above-mentioned (74) by N, may be made the ciphertext.

C=(m₁′c₁+m₂′c₂+ . . . +mₖ′cₖ) mod N (89)

In the case where the ciphertext is expressed as shown in (74), the ground of security is based on the difficulty of specifying a real solution among a plurality of solutions of the linear Diophantine indefinite equation for finding unknown numbers x₁, x₂, . . . xₙ when a₁, a₂, . . . , aₙ and C are known integers in the equation shown in (90) below. On the other hand, in the case where the ciphertext is expressed as shown in (89), since the product-sum operation is performed and the product-sum value is transformed modulo N, the ground of security is based on the difficulty in the prime factorization of N. In this case, since N is publicized, the quantity of the information provided to the attacker is increased, but the attacker can only know the remainder of the product-sum operation result rather than the result of the product-sum operation, and therefore the difficulty of solving the linear Diophantine equation is enhanced.

C=a₁x₁+a₂x₂+ . . . +aₙxₙ (90)

(Fourth Embodiment)

Note that, in the third embodiment, while the information indicating the positions of the components of the message vector or the components of the random number vector in the extension message vector which are arbitrarily set by the entity as the sender is included in the ciphertext, it is also possible to send the information indicating such positions from an entity as the sender to an entity as the receiver, independently of the transmission of the ciphertext.

(Fifth Embodiment)

Note that, in the third and fourth embodiments, while the positions of the components of the message vector or the components of the random number vector in the extension message vector are arbitrarily set by an entity as the sender, it is also possible to arbitrarily set such positions by an entity as the receiver.

(Sixth Embodiment)

Moreover, in the third to fifth embodiments, while the multiplexed schemes in which two sets ({dᵢ^{(P)}}, {dᵢ^{(Q)}}) of the set of bases {dᵢ} consisting of k elements are generated are explained, it is certainly possible to similarly apply these third to fifth embodiments to a scheme in which one set of bases {dᵢ} is used like the above-described first embodiment.

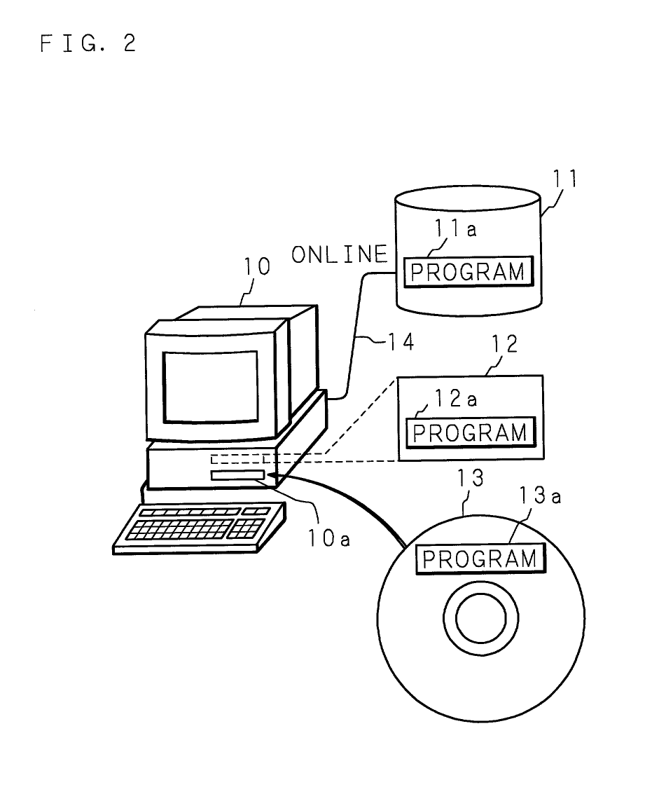

FIG. 2 is an illustration showing the structures of embodiments of a memory product of the present invention. The programs illustrated as examples here include a process of obtaining the extended plaintext vector g″ or the extension message vector m′ according to the procedure of the above-described encryption scheme and a process of creating the ciphertext C by calculating the inner-product of the obtained extended plaintext vector g″ or extension message vector m′ and the public-key vector c, and are recorded on the memory product explained below. Note that a computer 10 is provided for the entity as the sender.

In FIG. 2, a memory product 11 to be on-line connected to the computer 10 is implemented using a server computer, for example, WWW (World Wide Web), located in a place distant from the installation location of the computer 10, and a program 11a as mentioned above is recorded on the memory product 11. The program 11a read from the memory product 11 via a transmission medium 14 such as a communication line controls the computer 10 to create the ciphertext C.

A memory product 12 provided inside the computer 10 is implemented using, for example, a hard disk drive or a ROM to be installed in the computer 10, and a program 12a as mentioned above is recorded on the memory product 12. The program 12a read from the memory product 12 controls the computer 10 to create the ciphertext C.

A memory product 13 used by being loaded into a disk drive 10a installed in the computer 10 is implemented using, for example, a removable magneto-optical disk, CD-ROM, flexible disk or the like, and a program 13a as mentioned above is recorded on the memory product 13. The program 13a read from the memory product 13 controls the computer 10 to create the ciphertext C.

In the present invention, as described above, since the ciphertext is obtained using a publicized public vector and a composite vector produced by adding a random number vector whose components are a plurality of arbitrarily selected random numbers to a plaintext vector obtained by dividing the plaintext to be encrypted, a redundant portion (reduced portion) consisting of random numbers which need not to be encrypted is added, thereby increasing the density of the ciphertext, enhancing the invulnerability to the low-density attack based on the LLL algorithm and improving the security. Moreover, since the positions of the components of the plaintext vector or random number vector in the composite vector can be arbitrarily set by an entity as the sender or an entity as the receiver, it is difficult for the attacker to find the positions, thereby enabling a further improvement in the security. As a result, the present invention can greatly contribute to opening the door to practical applications of product-sum type cryptosystems.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An encryption method for obtaining ciphertext from plaintext, comprising the steps of:
creating a composite vector by adding a random number vector whose components are a plurality of arbitrarily selected random numbers to a plaintext vector having a plurality of components obtained by dividing a plaintext to be encrypted; and
obtaining a ciphertext by using the created composite vector and a publicized public vector.

2. The encryption method of claim 1, wherein
a result of product-sum operation of the components of said composite vector and the components of said public vector is made the ciphertext.

3. The encryption method of claim 1, wherein
a remainder formed by dividing a result of product-sum operation of the components of said composite vector and the components of said public vector by a modulus is made the ciphertext.

4. An encryption method for obtaining ciphertext from plaintext, comprising the steps of:
creating a third vector having (k+n) components by adding a second vector whose components are n arbitrarily selected random numbers to a first vector having k components obtained by dividing a plaintext to be encrypted into k parts; and
obtaining a ciphertext by using the created third vector and a fourth vector whose (k+n) components Dᵢ(1≦i≦k+n) are respectively set such that Dᵢ=d/dᵢ (where d=d₁d₂ . . . dₖ₊ₙ) by using an integer dᵢ.

5. The encryption method of claim 4, wherein
the ciphertext is obtained based on a product-sum operation of the components of said third vector and components of a public-key vector modulo-transformed based on said fourth vector.

6. An encryption method for obtaining ciphertext from plaintext, comprising the steps of:
creating a third vector having (k+n) components by adding a second vector whose components are n arbitrarily selected random numbers to a first vector having k components obtained by dividing a plaintext to be encrypted into k parts; and
obtaining a ciphertext by using the created third vector and a fourth vector whose (k+n) components Vᵢ (1≦i≦k+n) are respectively set such that Vᵢ=(d/dᵢ)·vᵢ (where d=d₁d₂ . . . dₖ₊ₙ) by using an integer dᵢ.

7. The encryption method of claim 6, wherein
gcd(Vᵢ, dᵢ)=1 is satisfied.

8. The encryption method of claim 6, wherein
the ciphertext is obtained based on a product-sum operation of the components of said third vector and components of a public-key vector modulo-transformed based on said fourth vector.

9. An encryption method for obtaining ciphertext from plaintext, comprising the steps of:
creating a third vector having (k+n) components by adding a second vector whose components are n arbitrarily selected random numbers to a first vector having k components obtained by dividing a plaintext to be encrypted into k parts; and
obtaining a ciphertext by using the created third vector and L sets (L≧2) of fourth vector whose (k+n) components Dᵢ^{(y)}(1≦i≦k+n, 1≦y≦L) are respectively set such that Dᵢ^{(y)}=d^{(y)}/dᵢ^{(y)} (where d^{(y)}=d₁^{(y)}d₂^{(y)} . . . dₖ₊ₙ^{(y)}) in each set by using L sets of integers dᵢ^{(y)}.

10. The encryption method of claim 9, wherein
the ciphertext is obtained based on a product-sum operation of the components of said third vector and components of a public-key vector modulo-transformed based on said fourth vector.

11. An encryption method for obtaining ciphertext from plaintext, comprising the steps of:
creating a third vector having (k+n) components by adding a second vector whose components are n arbitrarily selected random numbers to a first vector having k components obtained by dividing a plaintext to be encrypted into k parts; and
obtaining a ciphertext by using the created third vector and L sets (L≧2) of fourth vector whose (k+n) components Vᵢ^{(y)} (1≦i≦k+n, 1≦y≦L) are respectively set such that Vᵢ^{(y)}=(d^{(y)}/dᵢ^{(y)})·vᵢ^{(y)} (where d^{(y)}=d₁^{(y)}d₂^{(y)} . . . dₖ₊ₙ^{(y)}) in each set by using L sets of integers dᵢ^{(y)} and random numbers vᵢ^{(y)}.

12. The encryption method of claim 11, wherein
gcd(Vᵢ^{(y)}, dᵢ^{(y)})=1 is satisfied.

13. The encryption method of claim 11, wherein
gcd(dᵢ^{(y)}, dⱼ^{(y)})=1 (1≦j≦k+n) is satisfied.

14. The encryption method of claim 11, wherein
the ciphertext is obtained based on a product-sum operation of the components of said third vector and components of a public-key vector modulo-transformed based on said fourth vector.

15. An encryption method for obtaining ciphertext from plaintext, comprising the steps of:
creating a fourth vector having K(=k+n+h) components by adding together a first vector having k components obtained by dividing a plaintext to be encrypted, a second vector whose components are n arbitrarily selected random numbers and a third vector having h components indicating information identifying positions of said k components or said n components; and
obtaining a ciphertext by using the created fourth vector and a publicized fifth vector.

16. The encryption method of claim 15, wherein
the ciphertext is composed of a plurality of blocks obtained by using said fourth vector and said fifth vector, and positions of said h components in said fourth vector are identical in each block.

17. The encryption method of claim 15, wherein
the ciphertext is composed of a plurality of blocks obtained by using said fourth vector and said fifth vector, and positions of said k components or said n components in said fourth vector in each block are decided according to said k components in the previous block.

18. The encryption method of claim 15, wherein
the ciphertext is composed of one block obtained by using said fourth vector and said fifth vector and a plurality of blocks obtained by using said fifth vector and said fourth vector in which h components of said third vector are substituted with h components obtained by dividing a plaintext, and positions of (k+h) components or said n components in said fourth vector in each block are decided according to said k or (k+h) components obtained by dividing the plaintext in the previous block.

19. The encryption method of claim 15, wherein
said fifth vector is generated using a sixth vector whose components Dᵢ (1≦i≦K) are respectively set such that Dᵢ=(d/dᵢ) (where d=d₁d₂ . . . d_{K}) by using an integer dᵢ.

20. The encryption method of claim 19, wherein
the ciphertext is obtained based on a product-sum operation of the components of said fourth vector and components of said fifth vector modulo-transformed based on said sixth vector.

21. The encryption method of claim 15, wherein
said fifth vector is generated using a sixth vector whose components Vᵢ (1≦i≦K) are respectively set such that Vᵢ=(d/dᵢ)·vᵢ (where d=d₁d₂ . . . d_{K}) by using an integer dᵢ and random number vᵢ.

22. The encryption method of claim 21, wherein
gcd(Vᵢ, dᵢ)=1 is satisfied.

23. The encryption method of claim 21, wherein
the ciphertext is obtained based on a product-sum operation of the components of said fourth vector and components of said fifth vector modulo-transformed based on said sixth vector.

24. The encryption method of claim 15, wherein
said fifth vector is generated using L sets (L≧2) of sixth vector whose K components Dᵢ^{(y)} (1≦i≦K, 1≦y≦L) are respectively set such that Dᵢ^{(y)}=d^{(y)}/dᵢ^{(y)} (where d^{(y)}=d₁^{(y)}d₂^{(y)} . . . d_{K}^{(y)}) in each set by using L sets of integers dᵢ^{(y)}.

25. The encryption method of claim 24, wherein
the ciphertext is obtained based on a product-sum operation of the components of said fourth vector and components of said fifth vector modulo-transformed based on said sixth vector.

26. The encryption method of claim 15, wherein
said fifth vector is generated using L sets (L≧2) of sixth vector whose K components Vᵢ^{(y)} (1≦i≦k+n, 1≦y≦L) are respectively set such that Vᵢ^{(y)}=(d^{(y)}/dᵢ^{(y)})·vᵢ^{(y)} (where d^{(y)}=d₁^{(y)}d₂^{(y)} . . . d_{K}^{(y)}) in each set by using L sets of integers dᵢ^{(y)} and random numbers vᵢ^{(y)}.

27. The encryption method of claim 26, wherein
gcd(Vᵢ^{(y)}, dᵢ^{(y)})=1 is satisfied.

28. The encryption method of claim 26, wherein
gcd(dᵢ^{(y)}, dⱼ^{(y)})=1 (1≦j≦K) is satisfied.

29. The encryption method of claim 26, wherein
the ciphertext is obtained based on a product-sum operation of the components of said fourth vector and components of said fifth vector modulo-transformed based on said sixth vector.

30. A decryption method for decrypting a ciphertext obtained using the encryption method of claim 1, wherein
the components of said plaintext vector are decrypted independently of the components of said random number vector.

31. A decryption method for decrypting a ciphertext obtained using the encryption method of claim 1, wherein
the ciphertext is decrypted into the plaintext while identifying positions of the components of said plaintext vector.

32. A decryption method for decrypting a ciphertext obtained using the encryption method of claim 15, wherein
the ciphertext is decrypted into the plaintext while identifying positions of the components of said first vector.

33. A cryptographic communication method for performing information communication between entities, comprising the steps of:
creating a ciphertext from a plaintext at a first entity, according to the encryption method of claim 1, and transmitting the ciphertext to a second entity; and
decrypting the transmitted ciphertext into the plaintext at the second entity,
wherein positions of the components of said plaintext vector or the components of said random number vector in said composite vector are set at the first entity, and information indicating the set positions is sent to the second entity.

34. The cryptographic communication method of claim 33, wherein
the information indicating the set positions is included in a ciphertext to be created, and the ciphertext including the information is transmitted to the second entity.

35. A cryptographic communication method for performing information communication between entities, comprising the steps of:
creating a ciphertext from a plaintext at a first entity, according to the encryption method of claim 1, and transmitting the ciphertext to a second entity; and
decrypting the transmitted ciphertext into the plaintext at the second entity,
wherein positions of the components of said plaintext vector or the components of said random number vector in said composite vector are set at the second entity, and information indicating the set positions is sent to the first entity.

36. A cryptographic communication system for performing information communication using ciphertext between entities, comprising:
an encryptor for creating a ciphertext from a plaintext by using the encryption method of claim 1;
a communication channel for transmitting the created ciphertext from a first entity to a second entity; and
a decryptor for decrypting the transmitted ciphertext into the plaintext.

37. A computer memory product having computer readable program code means for causing a computer to create product-sum type ciphertext from plaintext, said computer readable program code means comprising:
program code means for causing the computer to create a composite vector by adding a random number vector whose components are a plurality of arbitrarily selected random numbers to a plaintext vector having a plurality of components obtained by dividing a plaintext to be encrypted; and
program code means for causing the computer to create a ciphertext by using said composite vector and a publicized public vector.

38. A computer data signal embodied in a carrier wave for transmitting a program, the program being configured to cause a computer to create product-sum type ciphertext from plaintext, comprising:
a code segment for causing the computer to create a composite vector by adding a random number vector whose components are a plurality of arbitrarily selected random numbers to a plaintext vector having a plurality of components obtained by dividing a plaintext to be encrypted; and
a code segment for causing the computer to create a ciphertext by using said composite vector and a publicized public vector.
